(19) United States
(12) Patent Application Publication
(10) Pub. No.: US 2008/0089323 A1
(43) Pub. Date: Apr. 17, 2008

(54) SYSTEM AND METHOD FOR ASSIGNING VIRTUAL LOCAL AREA NETWORKS

(75) Inventors: MARK A. ELIAS, EASTPOINTE, MI (US); SHERRY SOJA-MOLLOY, ALLEN PARK, MI (US); STEVEN T. KENNEDY, MARTINEZ, CA (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/549,287

(22) Filed: Oct. 13, 2006

(51) Int. Cl. H04L 12/56

(52) U.S. Cl. 370/389; 370/401

(57) ABSTRACT

A system and method for assigning Virtual Local Area Networks (VLANs). A system that incorporates teachings of the present disclosure may include, for example, an Access Point (AP) having a switching element that assigns a computing device to a VLAN according to a Media Access Control (MAC) address of the computing device. Other embodiments are disclosed.

### FIELD OF THE DISCLOSURE

The present disclosure relates generally to packet switched networks, and more specifically to a system and method for assigning Virtual Local Area Networks.

### BACKGROUND

Access Points (APs) with Ethernet switching capability support segregation of user traffic into Virtual Local Area Networks (VLANs) by the addition of an Ethernet header that includes a VLAN ID. Ethernet switch ports are either hard coded to be part of a single VLAN or are “span” ports that are VLAN agnostic. When a computing device interconnects to a network of one or more APs, it is common to encounter situations where the computing device cannot connect to the correct VLAN because of the pre-configuration of the VLAN ID on the port of the AP.

A need therefore arises for a system and method for assigning VLANs.

### BRIEF DESCRIPTION OF THE DRAWINGS

FIG. 1 depicts an exemplary embodiment of a communication system;

FIG. 2 depicts an exemplary method operating in the communication system; and

FIG. 3 is a diagrammatic representation of a machine in the form of a computer system within which a set of instructions, when executed, may cause the machine to perform any one or more of the methodologies discussed herein.

### DETAILED DESCRIPTION

Embodiments in accordance with the present disclosure provide a system and method for assigning VLANs.

In a first embodiment of the present disclosure, an Access Point (AP) can have a switching element that assigns a computing device to a Virtual Local Area Network (VLAN) according to a Media Access Control (MAC) address of the computing device.

In a second embodiment of the present disclosure, a Dynamic Host Configuration Protocol (DHCP) server can have a computing element that assigns a VLAN to a computing device according to a MAC address of the computing device.

In a third embodiment of the present disclosure, a computing device can have a computing element that receives an assignment to a VLAN according to a MAC address of the computing device.

In a fourth embodiment of the present disclosure, a computer-readable storage medium can have computer instructions for assigning a computing device to a Virtual Local Area Network (VLAN) according to a Media Access Control (MAC) address of the computing device.

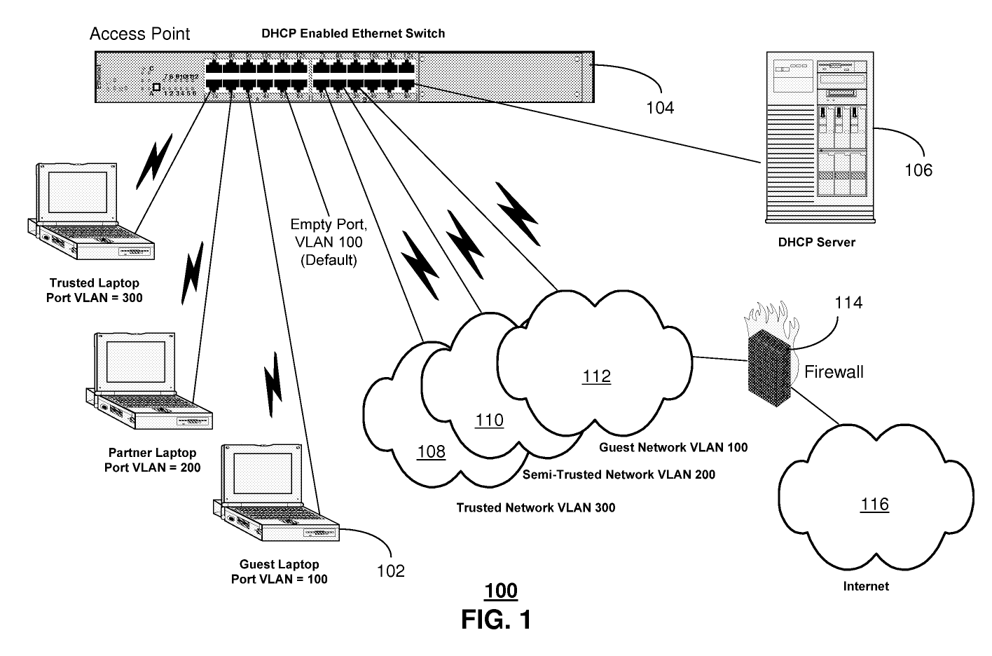

FIG. 1 depicts an exemplary embodiment of a communication system 100. The communication system 100 comprises a number of computing devices 102, an Access Point (AP) 104, and a Dynamic Host Configuration Protocol (DHCP) server 106. The computing devices 102 can be embodied in desktop computers, laptop computers, Personal Digital Assistants (PDAs), or a cellular phone with IP data capabilities, just to mention a few. The AP 104 can comprise a DHCP-enabled Ethernet switch, or other suitable packet switching device. The AP 104 has a switching element for communicating with a DHCP server 106, and for exchanging packet traffic between the computing device 102 and other network elements in the communication system 100. The DHCP server 106 has a computing element for retrieving VLAN IDs as will be described shortly. The DHCP server 106 can alternatively be represented by a DHCP element which is an integral part of the AP 104.

The AP 104 can have a transmission element utilizing common technology for interfacing to the computing devices 102 and the DHCP server 106. The transmission element can conform to any number of wireline and wireless communication protocols such as IEEE's family of 802 protocols (e.g., 802.1 through 802.22). When connected, the computing devices 102 utilizes a transmission element conforming to one or more of the aforementioned communication protocols for communicating with other devices by way of one of the VLANs 108-112, and/or through the firewall 114 out to the Internet 116. The computing devices 102 also have a computing element for performing the functions disclosed herein.

The computing elements of the DHCP server 106 and/or computing devices 102, as well as the switching element of the AP 104, and the transmission elements of the AP 104 and computing devices can be embodied in well known hardware and/or software technologies utilized at the present time.

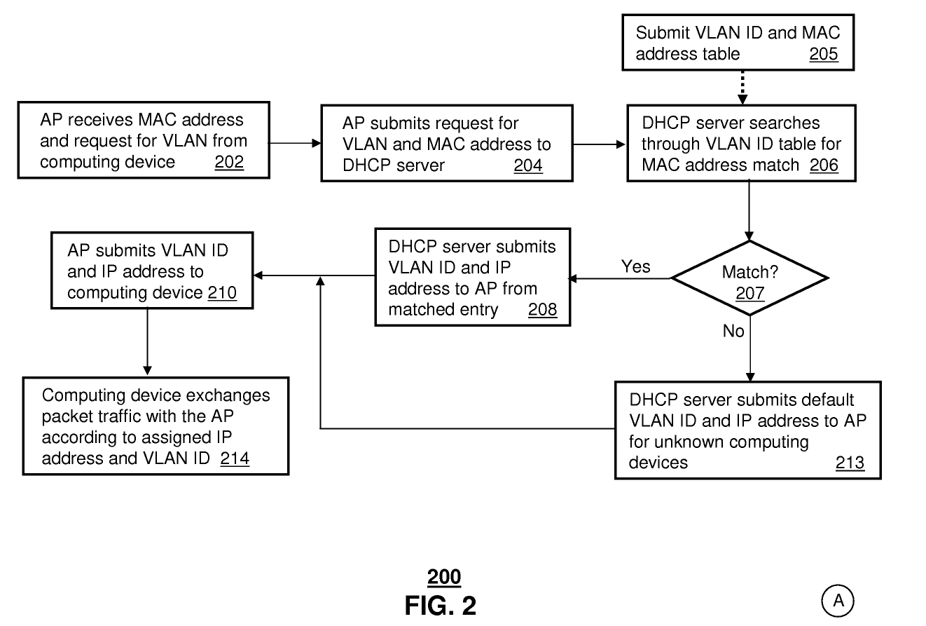

The functions of the aforementioned network elements can be described by an exemplary method 200 operating in the communication system 100 as depicted in FIG. 2. Method 200 begins with step 202 in which the AP 104 receives from a select computing device 102 a MAC address and a request for VLAN access. In step 204, the AP 104 submits the request for the VLAN and the MAC address to the DHCP server 106. The DHCP server 106 searches in step 206 through a table utilizing the MAC address as an index to an IP address and a VLAN ID. If a match is found in step 207, an IP address is assigned in step 208 by the DHCP server 106 to the computing device 102 according to its MAC address using methods similar to those utilized by DHCP servers today. The VLAN ID associated with the MAC address and the IP address are then submitted to the AP 104 in the same step. If no match is found to the MAC address and the DHCP server 106 is configured to support unknown MAC addresses, an IP address and VLAN ID would be assigned in step 213 from a set of addresses defined for use with previously unknown computing devices 102.

The AP 104 in step 210 submits the VLAN ID and IP address to the computing device 102 making the request according to the information supplied in either of steps 208 and 213. Upon receiving this information in step 214, the computing device 102 is enabled to begin exchanging packet traffic with the AP 104 according to the assigned IP address and VLAN ID. The VLAN assigned by the DHCP server 106 determines the operational privileges given to the computing device 102. These assignments can be pre-programmed in the DHCP server 106, or can be periodically updated by an external source (such as an administrated) which supplies in step 205 a VLAN ID and MAC address table to the DHCP server 106.

FIG. 1 provides several examples of VLAN assignments with varied operational privileges. For example a VLAN ID of 300 is assigned to a computing device 102 for access to VLAN network 108. This assignment represents full operational privileges for an end user of the computing device 102 coupled to VLAN 300. Full privileges can represent access to confidential database information, software applications, documentation, and so on. Such an assignment can be limited to known employees of an enterprise.

In another situation, the DHCP server 106 can assign VLAN 200 to a computing device 102 that receives semi-trusted network privileges. In this instance, confidential information of the enterprise can be restricted while software applications can be accessed for maintenance purposes. Such an assignment can be given, for example, to maintenance personnel. In yet another context, the DHCP server 106 can assign VLAN 100 to a computing device 102 that receives guest network privileges. In this instance, confidential information and software applications of the enterprise are restricted while access to the Internet is allowed. Such an assignment can be given, for example, to guest personnel who are not associated with the enterprise.

The aforementioned method can be applied in a number of settings. For example, it can be applied to an enterprise setting for managing employee, administrators, and guest personnel. Method 200 can also be applied in a retail setting that offers its patrons wireless access to a number of applications (e.g., Voice over IP or VoIP, IP Multimedia Subsystem services or IMS services, etc.). In yet another embodiment, the foregoing embodiments can be applied in a residential setting in a multi-user household.

From present disclosure, it would be evident to an artisan with ordinary skill in the art that the aforementioned embodiments can be modified, reduced, or enhanced without departing from the scope and spirit of the claims described below. Accordingly, the reader is directed to the claims below for a fuller understanding of the breadth and scope of the present disclosure.

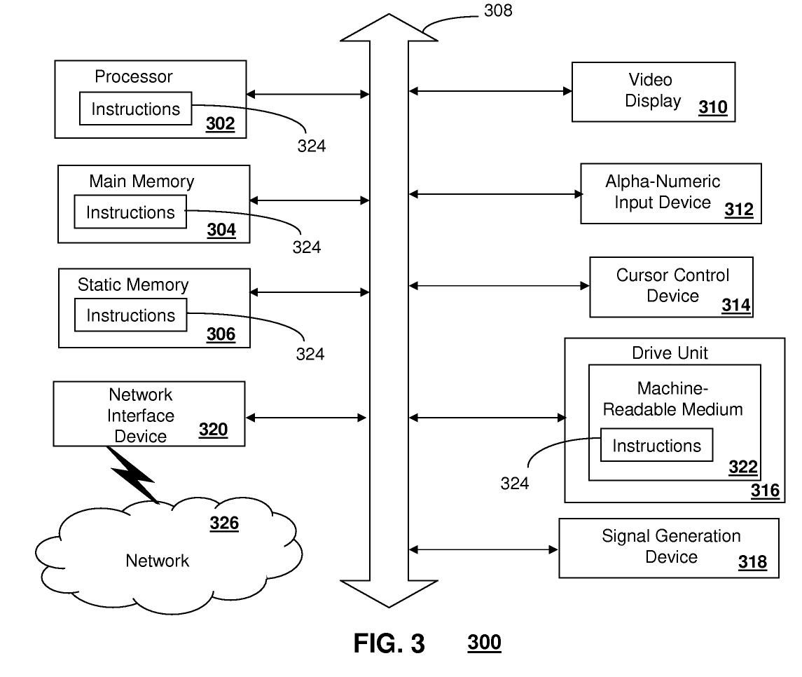

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An Access Point (AP), comprising a switching element that assigns a computing device to a Virtual Local Area Network (VLAN) according to a Media Access Control (MAC) address of the computing device.

2. The AP of claim 1, wherein the switching element receives from the computing device its MAC address and a request for a VLAN, submits the MAC address to a Dynamic Host Configuration Protocol (DHCP) element, and receives from the DHCP element an IP address and a VLAN ID corresponding to the VLAN assignment.

3. The AP of claim 2, wherein the switching element transmits to the computing device the IP address and the VLAN ID.

4. The AP of claim 2, wherein the DHCP element selects the VLAN from a plurality of VLANs having varying operational privileges according to the MAC address of the computing device.

5. The AP of claim 2, wherein the DHCP element comprises a DHCP server.

6. The AP of claim 1, wherein the switching element directs packet traffic from the computing device to the VLAN assigned.

7. The AP of claim 1, comprising a transmission element for exchanging packet traffic with the computing device.

8. The AP of claim 7, wherein the transmission element communicates with the computing device according to one among wireless and wireline interfaces.

9. The AP of claim 8, wherein the wireless and wireline interfaces conform to at least one among IEEE 802 standards.

10. The AP of claim 1, wherein the computing device comprises one among a desktop computer, a laptop computer, a Personal Digital Assistant (PDA), and a cellular phone.

11. A Dynamic Host Configuration Protocol (DHCP) server, comprising a computing element that assigns a Virtual Local Area Network (VLAN) to a computing device according to a Media Access Control (MAC) address of the computing device.

12. The DHCP server of claim 11, wherein the computing element selects the VLAN from a plurality of VLANs having varying operational privileges according to the MAC address of the computing device.

13. The DHCP server of claim 11, wherein the computing element receives from an Access Point (AP) the MAC address and a request for a VLAN, retrieves an IP address and a VLAN ID corresponding to the VLAN assignment according to the MAC address, and submits the VLAN ID and IP address to the AP.

14. The DHCP server of claim 13, wherein the computing element stores a plurality of VLAN IDs with a corresponding plurality of MAC addresses.

15. The DHCP server of claim 13, wherein the DHCP server is an integral part of the AP.

16. A computing device, comprising a computing element that receives an assignment to a Virtual Local Area Network (VLAN) according to a Media Access Control (MAC) address of the computing device.

17. The computing device of claim 16, wherein the computing element submits the MAC address and a request for a VLAN assignment to an Access Point (AP), receives from the AP an IP address and a VLAN ID associated with the VLAN assignment, and exchanges packet traffic with the AP according to the IP address and VLAN ID.

18. The computing device of claim 17, wherein the AP receives the IP address and VLAN ID assignments from a Dynamic Host Configuration Protocol (DHCP) element which determines said assignments according to the MAC address of the computing device.

19. The computing device of claim 17, comprising a transmission element for exchanging packet traffic with the AP according to one among wireless and wireline interfaces.

20. The computing device of claim 19, wherein the wireless and wireline interfaces conform to at least one among IEEE 802 standards.

21. A computer-readable storage medium, comprising computer instructions for assigning a computing device to a Virtual Local Area Network (VLAN) according to a Media Access Control (MAC) address of the computing device.
